(19) United States
(12) Patent Application Publication
(10) Pub. No.: US 2012/0221703 A1
(43) Pub. Date: Aug. 30, 2012

(54) METHOD AND SYSTEM FOR DATA EXCHANGE BETWEEN A VEHICLE AND A SERVER

(75) Inventors: Andreas Schwager, Waiblingen (DE); Renaud Difrancesco, London (GB)

(73) Assignee: Sony Corporation, Minato-ku, Tokyo (JP)

(21) Appl. No.: 13/391,645

(22) PCT Filed: Aug. 19, 2010
(86) PCT No.: PCT/EP2010/005095

§ 371 Date: May 7, 2012

(30) Foreign Application Priority Data
Sep. 1, 2009 (EP) 09011230.1

(51) Int. Cl. G06F 15/173

(52) U.S. Cl. 709/223

(57) ABSTRACT

A method for data exchange between a vehicle and a server, the vehicle including a battery and a first communication unit, the server including a second communication unit. The method connects the first communication unit and the second communication unit via a connection line wherein the connection line is adapted for charging the battery via a power supply unit and exchanges data between the first communication unit and the second communication unit via the connection line.

An embodiment of the invention relates to a method and system for data exchange between a vehicle and server. A further embodiment of the invention relates to a system comprising a vehicle and a server.

### BACKGROUND

Modern automotive systems heavily rely on software and data systems, e.g. control and entertainment systems. Just to mention a few applications among the vast variety imaginable: Many components of an automotive system are triggered by software and tuned by software parameters. The driver of a vehicle can be informed accurately about the level of water, oil or fuel while driving. In addition, navigational systems nowadays heavily rely on software and sensor data of automotive systems in order to provide their users with most accurate information. On-board entertainment systems for watching video, enjoying music or podcasts, games require application data as well as sometimes the devices rendering these services need a software update. In addition, individual driver information for conformity like seat positions, shock absorber settings (sportive or comfort), preferred roads to select and many others are desirably adjustable parameters.

Therefore, there is a need for appropriate data exchange between the automotive system and its environment for exploiting the full potential of e.g. control and entertainment systems in automotive environments. To establish such data exchange, both units have to be connected to each other in some way. Nowadays, this is often realized by employing wireless or special network adapters, which leads to a huge variety of incompatible techniques and thereby higher costs.

### BRIEF SUMMARY

It is an object of the invention to provide a method and system for enabling the exchange of data between a vehicle and other objects.

This object is solved by a method and system according to claims 1, 5. 9, and 11.

Further details of the invention will become apparent from a consideration of the drawings and ensuing description.

### BRIEF DESCRIPTION OF THE SEVERAL VIEWS OF THE DRAWINGS

The accompanying drawings are included to provide a further understanding of embodiments and are incorporated in and constitute a part of this specification. The drawings illustrate embodiments and together with the description serve to explain principles of embodiments. Other embodiments and many of the intended advantages of embodiments will be readily appreciated as they become better understood by reference to the following detailed description. The elements of the drawings are not necessarily to scale relative to each other. Like reference numerals designate corresponding similar parts.

FIG. 1 shows an embodiment of the invention.

FIG. 2 shows a schematic flowchart of an embodiment of the invention.

FIG. 3 shows an embodiment of a vehicle.

FIG. 4 shows an embodiment of vehicle being connected to a server.

FIG. 5 shows a further embodiment of connecting a vehicle to server.

FIG. 6 shows a further embodiment of the invention where the server is adapted to be a gateway to computer network.

### DETAILED DESCRIPTION

It is to be understood that other embodiments may be utilized and structural or logical changes may be made without departing from the scope of the invention. The following detailed description, therefore, is not to be taken in a limiting sense, and the scope of the present invention is defined by the appended claims.

It is to be understood that the features of the various embodiments described herein may be combined with each other, unless specifically noted otherwise.

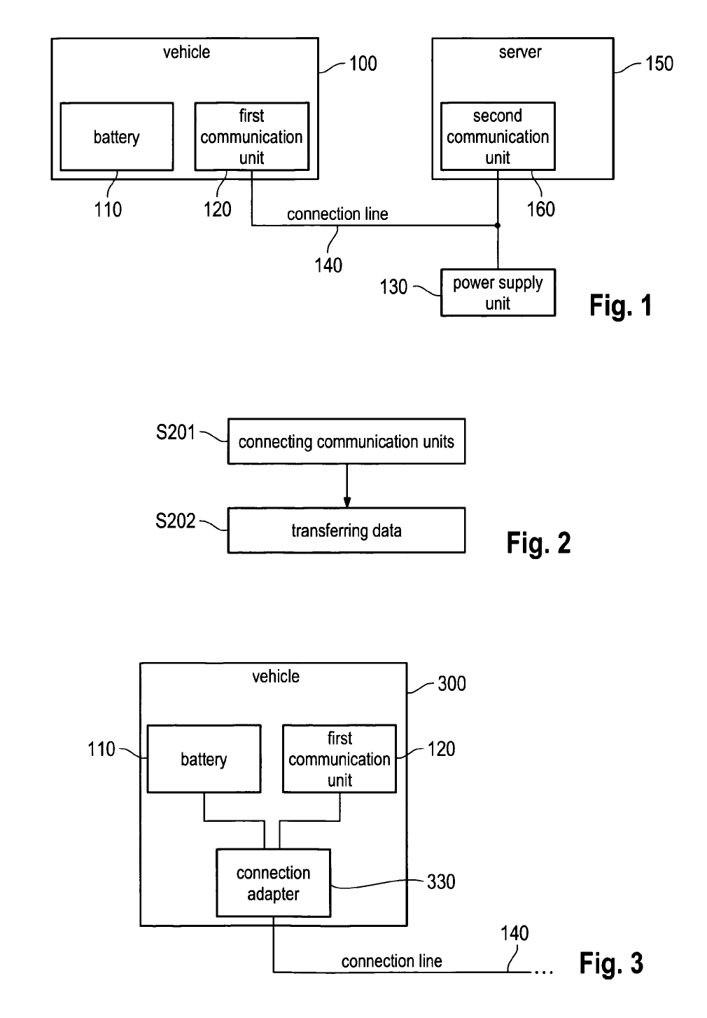

FIG. 1 shows an embodiment of the present invention. The system for data exchange comprises a vehicle 100 and a server 150, the vehicle including a battery 110 and a first communication unit 120. The server 150 includes a second communication unit 160. A connection exists between the first communication unit 120 and the second communication unit 160 via a connection line 140, wherein this connection line 140 is adapted for charging the battery via a power supply unit 130. This connection line 140 is adapted to exchange data between the first communication unit 120 and the second communication unit 160. A vehicle 100, as depicted here, is a vehicle that uses electricity to move. Hybrid vehicles or vehicles using more than one power source are also imaginable. In the present embodiment, this is a hybrid electric vehicle which combines an internal combustion engine (not shown) and one or more electric motors (not shown) energized by a battery 110. However, it is obvious to a person skilled in the art that other types of vehicles are imaginable and the use is not restricted to one battery or a combustion engine or a combination thereof. Vehicles relying completely on electric power for movement are also conceivable and covered by the present invention. In addition, vehicles may comprise a plurality of means of transportation and/or mobility. Among these means may be cars, ships, planes, trains, and motorcycles. However the means are not limited to these specific types. The server 150 depicted in FIG. 1 is a PC server or a gateway to a computer network like the Internet allowing access to and processing data. This will be further discussed later on with regard to FIG. 7.

The communication between the vehicle 100 and the server 150 is realized by the first communication unit 120 and the second communication unit 160 that are interconnected by the connection line 140. In the present embodiment of the invention, these communication units 120, 160 are PLC modems allowing data exchange via a power line and thereby only requiring a single cable to connect the first communication unit 120 and the second communication unit 160. However, the communication units 120, 160 are not limited to these types of modems and can be of any type of network adapter, e.g. Wireless Network, Ethernet.

Other than in the present embodiment, the connection line 140 can be a coupling or bundling of multiple connection media, i.e. cables. For example a coupling of a power line and an Ethernet cable is conceivable. By this, a data exchange via Ethernet and a charging of the battery is possible. However, by employing only one cable for simultaneously charging the battery and exchanging data the infrastructure is simplified.

These medias mentioned in the previous paragraph employ the techniques of the so-called Power line communication (PLC). PLC, also called mains communication, power line transmission or power line telecommunication (PLT), broadband power line (BPL), power band or power line networking (PLN) is a term describing several different systems for using power distribution wires for simultaneous distribution of data. A carrier can communicate voice and data by superimposing an analog signal of a standard 50 or 60 Hz alternating current. For indoor applications, PLC equipment can use household electrical power wiring as a transmission medium. This is a technique used e.g. for home networking or in-home automation for remote control of lighting and appliances without installation of additional wiring.

PLC can also be used for in-vehicle network communication of data, voice, and other multimedia signals by digital means over direct current (DC) battery power line. Various prototypes for in-vehicle network communication are available using automotive compatible protocols such as DC-bus, Controller Area Network bus (CAN-bus), and Local Interconnect Network bus (LIN-bus) over power line (DC-LIN).

All PLC systems have in common to impress a modulated carrier signal on the existing wiring system. Thereby, they employ different frequency bands for different types of PLC depending on the transmission characteristics of the underlying power wiring network. In PLC systems, data rates vary widely. Higher data rates generally imply shorter ranges.

Furthermore, the power supply unit 130 depicted in FIG. 1 can be any type of energy source, e.g. a connection point to the public power network, and can be based either on DC or AC power. In the present embodiment, the power being transferred to the vehicle as well as the data being exchanged use the same connection line.

The data being exchanged can be of a vast variety of types. Some types, but not limited to these, are service information, diagnosis information, multimedia data and power billing information. The first group comprises updates for the car navigation system, e.g. updated maps, special offers of local shops. In addition, shopping demands might be transmitted to the next supermarket when a vehicle arrives e.g. at a parking lot and is plugged to a charging device. Then, the goods can be delivered to the vehicle before the driver returns. Also, the exchange of tourist or web information about the local area is possible.

Furthermore, the present embodiment of the invention simplifies the exchange of diagnosis information required to tune the parameters of a specific component of the vehicle. Among these diagnosis information are the level of brake lining, the oil level, the amount of certain liquids such as water and antifreezing liquids, and many more. The power consumption of individual applications in the car might be measured, e.g. the lights, rear window heating, mirror heating, car radio. In winter season, if it is cold outside diagnosis information can be used to heat the driver seat, the windows, rear mirrors or the engine for a warm start.

Multimedia data such as A/V data, podcasts and many more may also be exchanged. Nowadays, multimedia data has either to be transferred to the vehicle by a dedicated data connection such as any wireless technologies or Ethernet, or other hardware means such as CD, DVD or USB sticks, either increasing the required infrastructure's complexity or limiting the user's comfort and flexibility. It is imaginable to offer a connection in the car to connect a computing device, e.g. a laptop or a PC, to the internet via PLC.

The present embodiment of the invention is well suited for the use and exchange of power billing information. Since a vehicle 100 of the present embodiment may have to be charged with electrical energy, the price information for this energy becomes relevant. Each time the vehicle 100 is connected to a server 150, power-billing information can be exchanged, wherein the customer accepts any price depending on the charging status of the battery 110. The prices for electrical energy may vary from time to time due to the load or availability of it. By that means, the vehicle 100 can be used as an electrical power buffer, i.e. power is stored when it is cheap and power can be fed back from the vehicle 100 to the electricity network when the power is expensive. It is possible to bargain energy prices with utilities and timing information can be used for determining when to exchange energy with the vehicle.

In FIG. 2, a schematic flowchart of an embodiment of the present invention is shown. First, after the vehicle 100 stands at a charging station (not shown) and the power cable has been plugged into the vehicle 100, in S201 the first communication unit 120 is connected to the second communication unit 160 via a connection line 140. Typical protocol information as known in the art is exchanged between the connected vehicle 100 and the server 150. After the connection has been established, S202 describes the data exchange between the first communication unit 120 and the second communication unit 160 via the connection line 140. In the case of the present embodiment, data is exchanged via PLC. The data exchange can take place either before, during, or after the charging process.

A further embodiment of the present invention is shown in FIG. 3. Here, a connection adapter 330 connects the connection line 140 with the battery 110 and the first communication unit 120. The connection adapter 330 is adapted to filter a power stream from a data stream through the connection line 140. Thereby, the power stream is forwarded to the battery 110 while the data stream is forwarded to the first communication unit 120 for handling further processing. In the present embodiment, the connection adapter 330 is separated from the first communication unit 120. However, as can be clearly understood by a person skilled in the art, the connection adapter 330 can also be integrated into the first communication unit 120 without changing the overall behavior. As has been pointed out in the previous paragraphs, in one embodiment of the present invention PLC is used for communicating between the vehicle 100 and the server 150. Hereby, the same connection line 140, i.e. cable, is shared for the power and the data stream. These two streams have to be separated. This separation is done by the connection adapter 330 that uses filter techniques well known in the art.

Various ways of establishing a physical connection between a vehicle 100 and a server 150 are conceivable, e.g. via a dedicated cable connection or via contact surfaces. Two of these possible connections are described in detail in the following paragraphs.

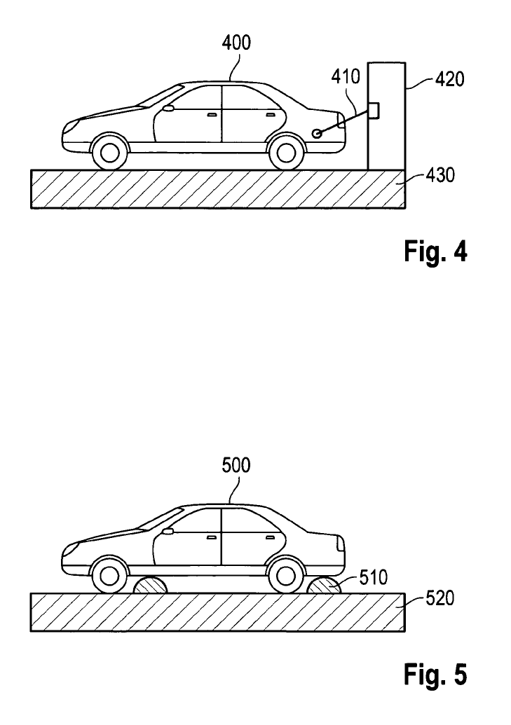

FIG. 4 shows an embodiment of vehicle 400 being connected to a server 150 (not shown). In this figure, the vehicle 400 is parked at a charging station 420. The charging station can be located anywhere on a solid ground 430, e.g. at a parking lot, a garage, a gas station. In this embodiment, the vehicle 400 is connected to the charging station 420 via cable 410, i.e. the connection line 40. The charging station 420 provides access to the power network (not shown) in addition to an incorporated server (not shown). The driver arrives and plugs the cable 410 attached to the charging station 420 into his vehicle 400 and thereby enabling a possible data exchange, as described previously.

In another embodiment, as depicted in FIG. 5, the cable connection might be omitted and replaced by rails 510 embedded in the road coating 520. By this means, the connection line 140 can be established without plugging a cable to the vehicle 500. The rails 510 are connected to the vehicle 500 and thereby establishing the connection.

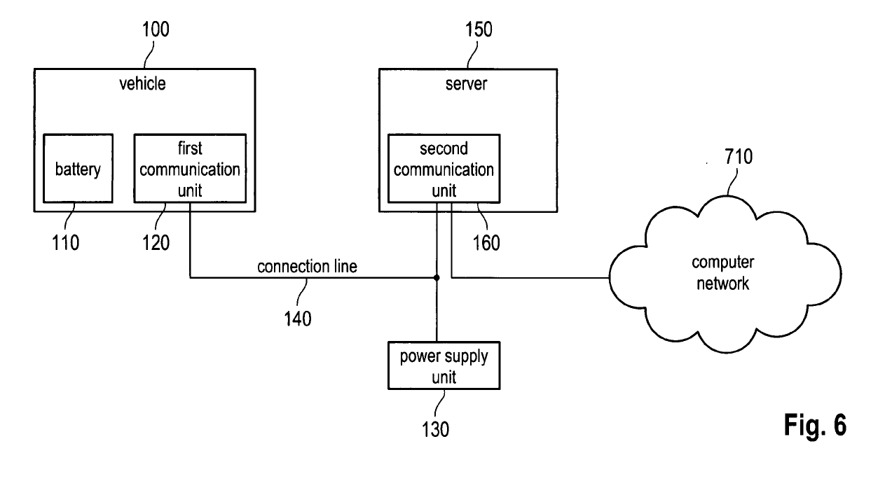

FIG. 6 depicts another embodiment of the present invention where the server 150 is connected to the vehicle 100. The server 150 is employed as a gateway to a computer network 710. The connection to the computer network 710 is transparent to the vehicle 100. This computer network can be any type of network, e.g. the Internet, a Local Area Network (LAN), a wireless network or even a mobile ad hoc network.

Although specific embodiments have been illustrated and described herein, it will be appreciated by those of ordinary skill in the art that a variety of alternate and/or equivalent implementations may be substituted for the specific embodiments shown and described without departing from the scope of the described embodiments. This application is intended to cover any adaptations or variations of the specific embodiments discussed herein. Therefore, it is intended that this invention be limited only by the claims and the equivalents thereof.

1. A method for data exchange between a vehicle and a server, the vehicle including a battery and a first communication unit, the server including a second communication unit, the method comprising:
connecting the first communication unit and the second communication unit via a connection line wherein the connection line is adapted for charging the battery via a power supply unit;
exchanging data between the first communication unit and the second communication unit via the connection line.

2. The method for data exchange between a vehicle and a server according to claim 1, wherein
the data exchanged between the first communication unit and the second communication unit via the connection line comprises multimedia data.

3. The method for data exchange between a vehicle and a server according to claim 1, wherein
the data exchanged between the first communication unit and the second communication unit via the connection line comprises power billing information or timing information when to exchange energy with the vehicle.

4. The method for data exchange between a vehicle and a server according to claim 1, wherein
the data exchanged between the first communication unit and the second communication unit via the connection line comprises diagnosis information.

5. A system for data exchange comprising:
a vehicle including
a battery, and
a first communication unit;
a server including
a second communication unit;
a connection line connecting the first communication unit with the second communication unit wherein the connection line is adapted for charging the battery via a power supply unit; wherein
the connection line being adapted to exchange data between the first communication unit and the second communication unit.

6. The system for data exchange according to claim 5, wherein
the first communication unit and the second communication unit are power line communication devices.

7. The system for data exchange according to claim 5, wherein
the connection line is a cable connected to the server and the vehicle.

8. The system for data exchange according to claim 5, wherein
the connection line is a plurality of rails embedded in the road coating.

9. A vehicle comprising
a battery, and
a first communication unit;
the first communication unit being configured to connect the vehicle to a second communication unit via a connection line, wherein the connection is adapted for charging the battery via a power supply unit.

10. The vehicle according to claim 9, further comprising:
a connection adapter for connecting the first communication unit and the battery with the connection line, wherein
the connection adapter is adapted to filter the power stream from the data stream through the connection line, the power stream being forwarded to the battery and the data stream to the first communication unit.

11. A server comprising
a second communication unit;
the second communication unit being configured to connect the server to a first communication unit via a connection line, wherein the first communication unit is located in a vehicle.
